(19) United States
(12) Patent Application Publication
(10) Pub. No.: US 2016/0162421 A1
(43) Pub. Date: Jun. 9, 2016

(54) LTR/OBFF DESIGN SCHEME FOR ETHERNET ADAPTER APPLICATION

(71) Applicants: Xuhong XIONG, San Diego, CA (US); Kevin ZHANG, San Diego, CA (US); Xiaofeng YAN, San Diego, CA (US); Jack DU, San Diego, CA (US); QUALCOMM INCORPORATED, San Diego, CA (US)

(72) Inventors: Xuhong Xiong, Shanghai (CN); Kevin Zhang, Shanghai (CN); Xiaofeng Yan, Shanghai (CN); Jack Du, Shanghai (CN)

(21) Appl. No.: 14/907,649

(22) PCT Filed: Aug. 7, 2013
(86) PCT No.: PCT/CN2013/080993

§ 371 Date: Jan. 26, 2016

(51) Int. Cl. G06F 13/20; G06F 13/40; G06F 13/42

(52) U.S. Cl. CPC G06F 13/20; G06F 13/4282; G06F 13/4068

(57) ABSTRACT

A method of reducing power consumption in a computing platform is disclosed. An endpoint-device that is coupled to the computing platform includes a first data buffer and a second data buffer. The first data buffer buffers outgoing data to be transmitted to an external device via a first communications medium. The second data buffer buffers incoming data received from the external device via the first communications medium. At least one of the first or second data buffers may selectively communicate with the computing platform, via a second communications medium, during an active window of the other data buffer. The active window may be requested by the first and/or second data buffers based, at least in part, on a system idle signal. For some embodiments, the first communications medium is an Ethernet link. Further, for some embodiments, the second communications medium is a Peripheral Component Interconnect Express (PCIe) link.

### TECHNICAL FIELD

The present embodiments relate generally to reducing power consumption in a communications platform, and specifically to reducing power consumption by placing the communications platform in a low-power idle state.

### BACKGROUND OF RELATED ART

Power consumption is a major consideration in the design of computing platforms. More specifically, many systems are designed to conserve energy during periods of low activity or inactivity. For example, the system may shut off one or more power-consuming devices (e.g., a clock signal generator and/or PLL) during such “idle” periods. Systems can reduce power consumption even further by scheduling (and/or rescheduling) activities to increase the “idle window.” For example, rather than allow each device in the system to send and receive data on its own schedule, a system controller may manage the activities of the individual devices around a schedule that is optimized to reduce energy consumption for the computing platform as a whole.

However, there is a platform response latency seen by the devices when the system enters a low power state, which can potentially result in Quality of Service (QoS) issues. In many computer systems, the controller may receive only coarse power management guidance from the operating system. The operating system is typically unable to provide finer guidance due to the unpredictability of bus master activity and/or asynchronous interrupt activity initiated by the devices. As a result, the controller typically predicts when devices are idle. However, incorrect predictions can cause performance issues, or even hardware failures.

The Peripheral Component Interconnect Express (“PCIe”) specification defines a Latency Tolerance Requirement (LTR) reporting mechanism that enables PCIe endpoints to communicate their service latency requirements for memory reads and writes (e.g., via LTR messages) to upstream entities (e.g., switches, root complex, etc.). Accordingly, the LTR reporting mechanism may enable all devices in the system to provide their service latency requirements to the controller, thus enabling the controller to dynamically generate a schedule for the entire system that is optimized for power savings.

The PCIe specification also defines an Optimized Buffer Flush/Fill (OBFF) Mechanism that enables a Root Complex (e.g., the computing platform) to report to endpoints (e.g., in a hierarchy) power state time windows. An OBFF indication is a hint—functions are still permitted to initiate bus mastering and/or interrupt traffic, although doing so may not be optimal for platform power and should be avoided when possible.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A device and method of operation are disclosed that may aid in reducing power consumption in a computing platform. For some embodiments, the device may include a transmit data buffer (TX buffer) to retrieve outgoing data from the computing platform, and to buffer the outgoing data to be transmitted to an external device; and a receive data buffer (RX buffer) to receive incoming data from an external device, and to buffer the incoming data to be forwarded to the computing platform. The TX buffer and RX buffer may communicate with the computing platform via a shared communications medium. For some embodiments, the TX buffer may selectively retrieve the outgoing data from the computing platform during an active window in which the communications medium is reserved for the RX buffer to transmit data to the computing platform. Furthermore, the RX buffer may selectively forward the incoming data to the computing platform during an active window in which the communications medium is reserved for the TX buffer to retrieve data from the computing platform.

For some embodiments, at least one of the RX and/or TX buffers may selectively request an active window based, at least in part, on a system idle signal. During an “accumulation” stage, the TX buffer may request a first active window and retrieve outgoing data from the computing platform, during the first active window, until an amount of data in the TX buffer reaches at least a first transmit threshold. The TX buffer may subsequently request a second active window if the amount of data in the TX buffer falls below a second transmit threshold (that is less than the first transmit threshold) and retrieve outgoing data from the computing platform, during the second active window, until the amount of data in the TX buffer reaches at least the first transmit threshold. The TX buffer may further request a third active window if the amount of data in the TX buffer falls below a third transmit threshold (that is less than the first transmit threshold and greater than the second transmit threshold) and the system idle signal indicates that the computing platform is in an active state. For some embodiments, the TX buffer may not request the third active window if the system idle signal indicates that the computing platform is in a low-power idle state or if the amount of data in the TX buffer is above the first and/or third transmit thresholds.

As the RX buffer receives incoming data from an external device, the RX buffer may request a first active window if an amount of data in the RX buffer exceeds a first receive threshold, while the system idle signal indicates that the computing platform is in an active state, and transmit incoming data to the computing platform during the first active window. For some embodiments, the RX buffer may not request and/or may terminate the first active window if the system idle signal indicates that the computing platform is in a low-power idle state or if the amount of data in the RX buffer is below at least the first receive threshold. The RX buffer may further request a second active window if the amount of data in the RX buffer reaches a second receive threshold (that is greater than the first receive threshold), and transmit data to the computing platform during the second active window until the amount of data in the RX buffer drops below a third receive threshold (that is less than the first receive threshold). For some embodiments, the RX buffer may “flush out” stale data that has been buffered for long durations. Accordingly, the RX buffer may request a third active window if any data has been stored in the RX buffer for longer than a threshold duration, and transmit data to the computing platform during the third active window until the amount of data in the RX buffer drops below the third receive threshold.

The buffer thresholds for the TX and RX buffers may be determined based on latency requirements of the respective data buffers. For some embodiments, the TX and/or RX buffers may additionally output a latency tolerance request (LTR) message to the computing platform to indicate their respective latency requirements. The TX and RX buffers may communicate with external devices via an Ethernet link (or other suitable communication connection). For some embodiments, the shared communications medium (used by the TX and RX buffers to communicate with the computing platform) may be a Peripheral Component Interconnect Express (PCIe) link. Furthermore, the system idle signal may be a PCIe Optimized Buffer Flush/Fill (OBFF) indicator signal.

By buffering incoming and outgoing data, and selectively communicating such data to and from the computing platform based on an “idle” (or “active”) state of the platform, the present embodiments may enable the computing platform to enter a low-power idle state more frequently and/or remain in the low-power idle state for longer durations. Furthermore, enabling one data buffer to “borrow” the active window of another data buffer allows the shared communications medium (e.g., PCIe link) to be used more efficiently (and sparingly), which may further enable the computing platform to remain in the idle state for even longer durations.

### BRIEF DESCRIPTION OF THE DRAWINGS

The present embodiments are illustrated by way of example and are not intended to be limited by the figures of the accompanying drawings, where:

FIG. 1 shows an embodiment of an endpoint device for transferring incoming data from an external device to a computing platform;

FIG. 2 is an illustrative flowchart depicting an exemplary operation for buffering incoming data in accordance with some embodiments;

FIG. 3 shows an embodiment of an endpoint device for transferring outgoing data from a computing platform to an external device;

FIG. 4 is an illustrative flowchart depicting an exemplary operation for buffering outgoing data in accordance with some embodiments;

FIG. 5 shows an embodiment of an endpoint device for transferring incoming and outgoing data over a shared communications medium between an external device and a computing platform;

FIG. 6 is an illustrative flowchart depicting an exemplary operation for buffering incoming and outgoing data in a coordinated fashion, in accordance with some embodiments;

FIG. 7 is an illustrative flowchart depicting an exemplary operation for buffering incoming data in coordination with outgoing data, in accordance with some embodiments;

FIG. 8 is an illustrative flowchart depicting an exemplary operation for buffering outgoing data in coordination with incoming data, in accordance with some embodiments;

FIG. 9 shows another embodiment of an endpoint device for transferring incoming and outgoing data over a shared communications medium between an external device and a computing platform; and

FIG. 10 shows yet another embodiment of an endpoint device for transferring incoming and outgoing data over a shared communications medium between an external device and a computing platform.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

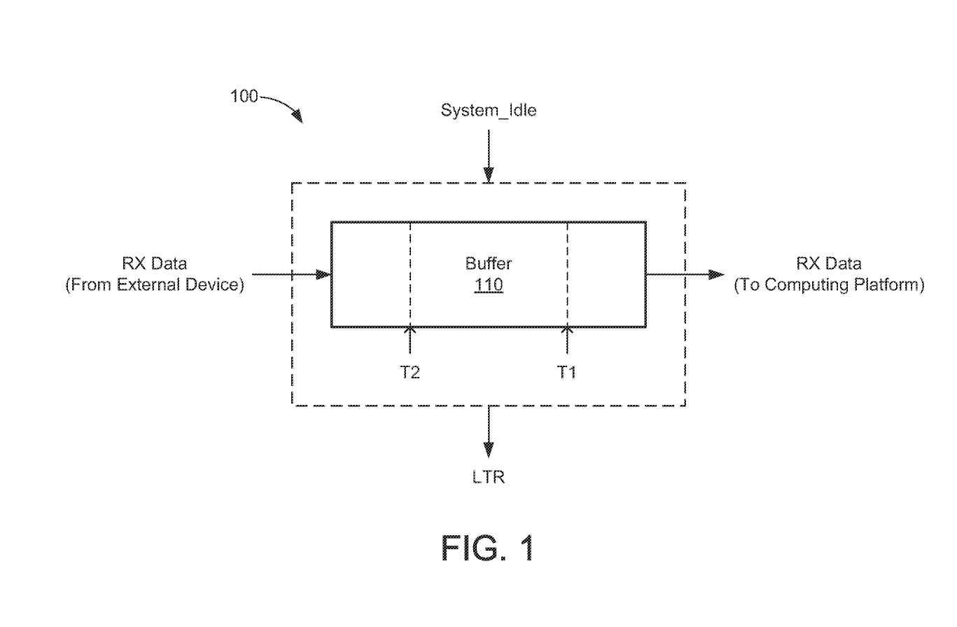

FIG. 1 shows an embodiment of an endpoint device 100 for transferring incoming data from an external device to a computing platform. For some embodiments, the endpoint device 100 may be a Peripheral Component Interconnect Express (PCIe) endpoint device (e.g., an Ethernet adapter) with support for Latency Tolerance Requirement (LTR) reporting. The device 100 includes a data buffer 110 that stores incoming (RX) data, which may be received from another device in a network. For some embodiments, the buffer 110 may correspond to a first-in first-out (FIFO) memory device.

The device 100 may output data from the buffer 110 to the computing platform in bursts, based on a power schedule of the platform. More specifically, two buffer thresholds T1 and T2 may control when data stored in the buffer 110 is released to the platform. The first buffer threshold T1 may represent a minimum data size for data bursts. Accordingly, the first buffer threshold T1 may ensure that blocks of data are delivered to the platform in an efficient manner, for example, to reduce the number of interrupts to a processor of the computing platform. This, in turn, may allow the platform to enter a low-power “idle” state more often and/or for longer durations of time.

The second buffer threshold T2 may represent a maximum buffer fill level. The data buffer 110 has a maximum storage capacity that, once reached, the buffer 110 may be unable to load and/or store additional RX data. Thus, the second buffer threshold T2 may ensure that data is “flushed” (e.g., substantially emptied) from the data buffer 110 before the buffer 110 reaches its maximum storage capacity. For some embodiments, the second buffer threshold T2 may account for latency requirements associated with the flushing of data from the buffer 110 and/or the transitioning of the platform from a low-power idle state to an active state. For example, data exceeding the second buffer threshold T2 may cause the device 100 to flush the data stored in the buffer 110 when there is still enough excess buffer capacity to store any subsequent RX data that may arrive during the latency period.

For some embodiments, the device 100 may output an LTR message to indicate its latency requirements to (e.g., a system controller of) the computing platform. For example, the latency requirements may be associated with the buffer capacity of the data buffer 110. Thus, the LTR message may indicate the amount of time it takes the data buffer 110 to output a burst of data and/or flush the data stored therein. For some embodiments, the LTR message may be based on the data rates at which the device 100 receives RX data and/or the rate at which the device 100 forwards RX data to the computing platform. The LTR message may be further based on the time it takes the computing platform to transition from a low-power idle state to an active state. For example, the device 100 may generate a lower LTR value (e.g., indicating reduced latency tolerances) when actively receiving RX data, and may generate a higher LTR value (e.g., indicating increased latency tolerances) when no RX data is being received.

For some embodiments, the device 100 may receive a system idle signal indicating a current power state of the platform. For example, the system idle signal may indicate an Optimized Buffer Flush/Fill (OBFF) event. The PCIe specification defines three OBFF events: “CPU Active,” indicating that the platform is active and available for all device actions; “OBFF,” indicating that data can be written to and read from main memory; and “Idle,” indicating that the platform is in a low-power idle state. The device 100 may use the information from the system idle signal to determine whether the computing platform is in an active or an idle state, and thus further control the output of data from the data buffer 110.

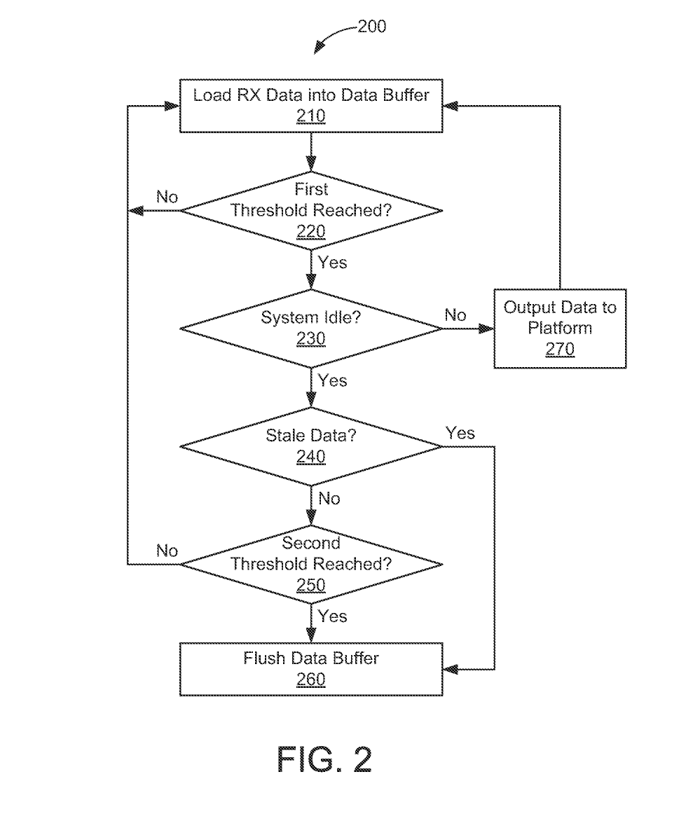

FIG. 2 is an illustrative flowchart depicting an exemplary operation 200 for buffering incoming data in accordance with some embodiments. With reference, for example, to FIG. 1, the device 100 receives an RX data signal and loads the received RX data into the data buffer 110 (210). As long as the first buffer threshold T1 has not been reached (220), the device 100 may continue to load RX data into the buffer 110 (210). As described above, the first buffer threshold T1 may correspond to a minimum data size for data bursts to the computing platform.

Once the buffer fill level has reached the first threshold T1 (220), the device 100 determines whether the platform is currently in a low-power idle state (230). For example, the device 100 may perform this determination based on the OBFF event (e.g., CPU Active, Idle, or OBFF) indicated by the system idle signal. If the device 100 determines that the platform is not in a low-power idle state (230), it may output a burst of data from the buffer 110 to the computing platform (270) while continuing to load RX data into the buffer 110 (210). Accordingly, the device 100 may output the data queued in the buffer 110 (270) whenever the first buffer threshold T1 is reached (220), as long as the system idle signal does not, e.g., indicate an OBFF Idle event (230).

If the device 100 determines that the platform is in a low-power idle state (230), it may then determine whether the buffer 110 contains any stale data (240). For example, the device 100 may include one or more counters or a timestamp mechanism to keep track of the data flowing into and out of the buffer 110. The timestamp mechanism may include a global timer or clock signal. Each time a data packet is received and stored in the buffer 110, a descriptor associated with the event is stored in a corresponding descriptor FIFO. Accordingly, the device 100 may monitor the latest descriptor (e.g., output by the descriptor FIFO), associated with the latest RX data packet that is to be transmitted to the computing platform, and compares it to the current time indicated by the global timer. The device 100 may thus determine the duration of storage for any RX data packet in the RX buffer 110 by comparing the timer values. For some embodiments, the device 100 may determine if any RX data has been stored in the buffer 110 for longer than a threshold duration. If the device 100 detects stale data in the buffer 110 (240), it may initiate a data flush operation (260) by outputting all or most of the data stored in the buffer 110 to the computing platform. In order to ensure that RX data is delivered to the computing platform in a timely manner, the device 100 may be configured to flush stale data from the buffer 110 regardless of whether the platform is in a low-power idle state.

If the buffer 110 does not contain any stale data (240), the device 100 may then determine whether the second buffer threshold T2 has been reached (250). As described above, the second buffer threshold T2 may be used to ensure that data is flushed from the buffer 110 before it reaches its maximum storage capacity. As long as the second threshold T2 has not been reached (250), the device 100 may continue to store RX data in the buffer 110 (210) without forwarding such data to the computing platform. This is to prevent the device 100 from unnecessarily interrupting the low-power idle state of the computing platform.

However, if the buffer fill level reaches the second threshold T2 (250), the device 100 may flush the data stored in the buffer 110 (260). As described above, the second buffer threshold T2 may ensure that the device 100 is able to flush the data from the buffer 110 while there is still enough excess buffer capacity available to store any subsequent RX data that may arrive during the buffer-flush latency period. Thus, in order to avoid potentially losing RX data, the device 100 may be configured to flush the data stored in the buffer 110 as soon as the second buffer threshold T2 is reached, regardless of whether the computing platform is in a low-power idle state.

By selectively outputting data stored by the data buffer 110 in bursts, based on the first buffer threshold T1 and the system idle signal (e.g., OBFF event information), the data buffering operation 200 may enable the computing platform to enter a low-power idle state more frequently and/or remain in the low-power state for longer durations. In addition, the operation 200 may ensure that no RX data is lost due to buffer overflow by flushing the data from the buffer 110 when the buffer fill level reaches the second buffer threshold T2. Since the device 100 typically does not control when RX data is sent by an external device, the present embodiments may ensure that the buffer 110 has enough storage capacity to continue buffering RX data regardless of when such data may arrive.

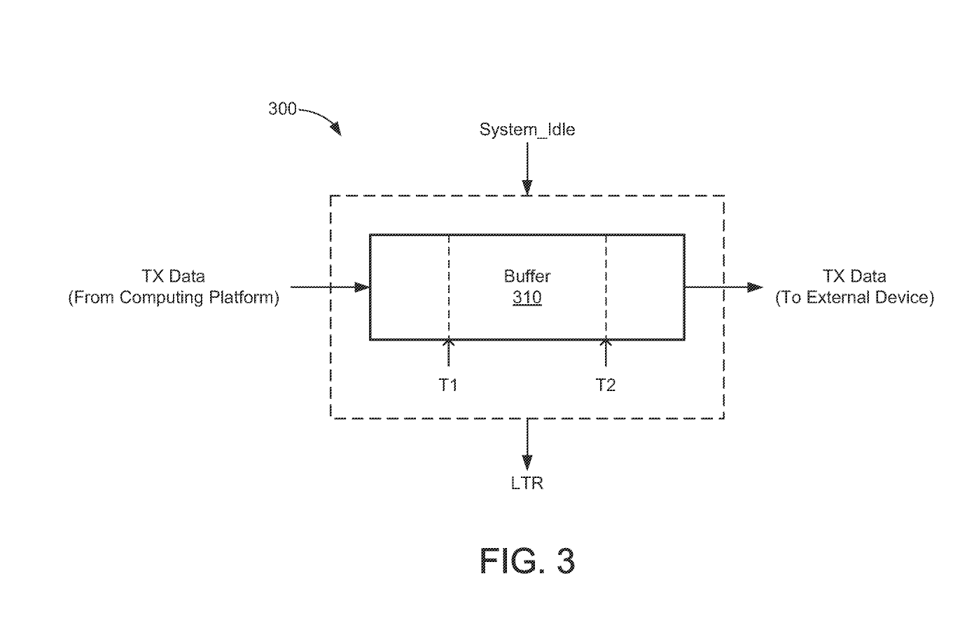

FIG. 3 shows an embodiment of an endpoint device 300 for transferring outgoing data from a computing platform to an external device. As described above, the endpoint device 300 may be a PCIe endpoint device (e.g., an Ethernet adapter) with support for LTR reporting. The device 300 includes a data buffer 310 that stores outgoing (TX) data that is to be transmitted to another device in a network. For some embodiments, the buffer 310 may correspond to a FIFO memory device.

Two buffer thresholds T1 and T2 may be used to control the fetching of TX data from the computing platform. Specifically, the first buffer threshold T1 may represent a buffer fill “cut-off” for the buffer 310 during an “accumulation stage” of a TX data buffering operation. In other words, the buffer 310 may accumulate outgoing data until the buffer fill level (i.e., the amount of data stored in the data buffer 310) reaches at least the first buffer threshold T1. For some embodiments, the first buffer threshold T1 may be substantially equal to the maximum storage capacity of the data buffer 310. For other embodiments, the first buffer threshold T1 may be less than the maximum storage capacity of the buffer 310.

The second buffer threshold T2 may represent a minimum buffer fill level for the buffer 310 when the computing platform is in a low-power idle state (e.g., when no TX data is being fetched by the device 300). Accordingly, when the buffer fill level falls below the second buffer threshold T2, the buffer 310 may resume actively retrieving TX data from the computing platform. For some embodiments, the second buffer threshold T2 may account for latency requirements associated with the retrieval of data from the computing platform and/or the transitioning of the platform from a low-power idle state to an active state. In this manner, the second buffer threshold T2 may be used to extend the frequency and/or duration for which the computing platform enters the idle state while the device 300 continues to output a steady (e.g., constant) stream of TX data to another device in the network.

For some embodiments, the device 300 may be configured to output an LTR message indicating its latency requirements (e.g., to a system controller). For example, the latency requirements may correspond with the buffer fill level of the data buffer 310. More specifically, the LTR message may indicate the amount of time it takes to completely empty the data buffer 310 (e.g., when the buffer fill level reaches the second buffer threshold T2) while no additional TX data is being retrieved from the computing platform. For some embodiments, the LTR message may be based on the data rates at which the device 300 retrieves TX data from the computing platform and/or outputs TX data to an external device. The LTR message may be further based on the time it takes the computing platform to transition from a low-power idle state to an active state. For example, the device 300 may produce a lower LTR value when actively transmitting TX data and a higher LTR value when no TX data is being transmitted.

For some embodiments, the device 300 may receive a system idle signal indicating a current power state of the platform. As described above, the system idle signal may indicate an OBFF event (e.g., CPU Active, OBFF, or Idle). The device 300 may use the information from the system idle signal to determine whether the computing platform is in an active or idle state, and thus further control the fetching or retrieval of data from the platform.

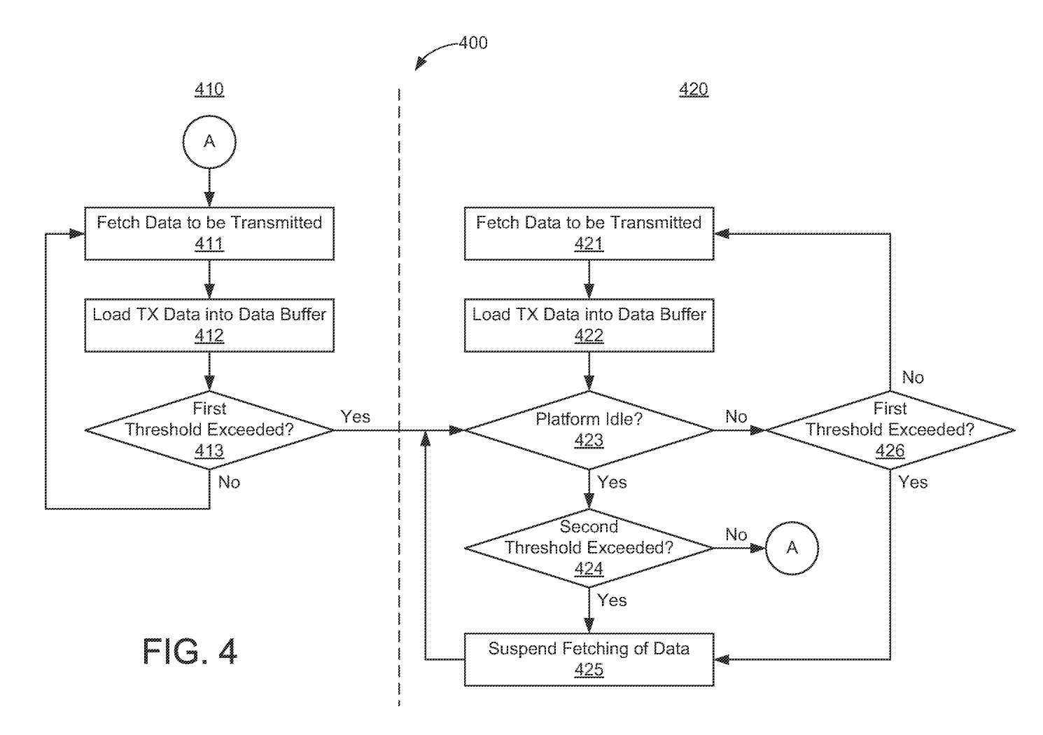

FIG. 4 is an illustrative flowchart depicting an exemplary operation 400 for buffering outgoing data in accordance with some embodiments. Specifically, the outgoing data buffering operation 400 may be subdivided into two stages: an accumulation stage (410) and a power-saving stage (420). With reference, for example, to FIG. 3, the device 300 first initiates the accumulation stage (410) by fetching TX data from the computing platform (411). The TX data is then loaded into the data buffer 310 (412) to be transmitted to another device in the network. For some embodiments, as long as the data buffer 310 is not empty, the device 300 may continuously output TX data from the data buffer 310 to an external device.

During the accumulation stage (410), the device 300 may continue to fetch TX data (411) and load the data into the data buffer 310 (412) as long as the buffer fill level has not reached the first buffer threshold T1 (413). For some embodiments, TX data may be loaded into the data buffer 310 at a higher rate than the TX data is output to the external device. As a result, data buffer 310 may continue to accumulate data during the accumulation stage (410) even while TX data is concurrently or simultaneously transmitted to the external device.

Once the buffer fill level has reached or exceeded the first buffer threshold T1 (413), the device 300 enters the power-saving stage (420). Specifically, the device 300 may subsequently determine whether the computing platform is currently in a low-power idle state (423). As described above, the device 300 may perform this determination based on the OBFF event indicated by the system idle signal. If the device 300 determines that the platform is not in a low-power idle state (423), it may then determine whether the buffer fill level currently exceeds the first buffer threshold T1 (426). If the buffer fill level is at or above the first buffer threshold T1 (426), the device 300 may temporarily suspend fetching of additional TX data (425) while continuing to monitor the idle state of the computing platform (423).

If the computing platform is not in a low-power idle state (423) and the buffer fill level is below the first buffer threshold T1 (426), the device 300 may proceed to fetch additional TX data from the computing platform (421) and load the data in the data buffer 310 (422). The data buffer 310 may accumulate more data while the computing platform is already in an active power state, since the platform may be able to respond to data fetch requests as soon as possible.

If, at any time, the device 300 determines that the computing platform is in a low-power idle state (423), the device 300 may subsequently determine whether the buffer fill level currently exceeds the second buffer threshold T2 (424). If the amount of data stored in the buffer 310 remains at or above the second buffer threshold T2 (424), the device 300 may temporarily suspend requests to fetch additional TX data (425) while continuing to monitor the idle state of the computing platform (423). If the computing platform is in a low-power idle state (423) and the buffer fill level falls below the second buffer threshold T2 (424), the device 300 may reenter the accumulation stage (410).

The data buffer operation 400 may enable the device 300 to continue transmitting TX data from the data buffer 310 while suspending requests to fetch additional TX data from the computing platform as long as the platform is in a low-power idle state and the buffer fill level has not fallen below the second buffer threshold T2. Moreover, if the buffer fill level falls below the second buffer threshold T2 while the platform is in a low-power idle state, the device 300 may begin re-accumulating TX data. This may enable the computing device 300 to deliver an uninterrupted transmission of TX data to an external device, while also increasing the duration of the low-power idle state of the computing platform.

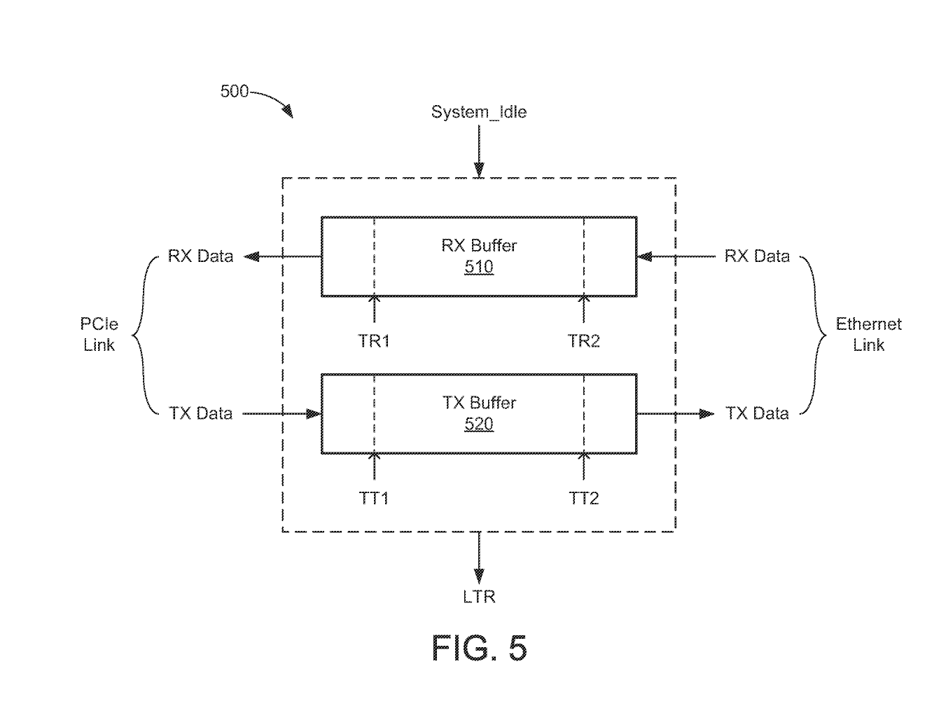

FIG. 5 shows an embodiment of an endpoint device 500 for transferring incoming and outgoing data over a shared communications medium between an external device and a computing platform. The device 500 includes an RX buffer 510 and a TX buffer 520, and may act as an interface for communications between the computing platform and the external device. For some embodiments, the device 500 may communicate with an external device via a network channel. It should be noted that the network channel may be a wired link (e.g., coaxial cable, fiber-optic line, twisted pair cable, etc.) or a wireless communications channel. For some embodiments, the device 500 communicates with the computing platform via a shared communications medium (e.g., a PCIe link) that allows both the RX buffer 510 and the TX buffer 520 to communicate with the computing platform using the same PCIe link.

The RX buffer 510 may temporarily store RX data received from an external device (e.g., via the Ethernet link) and forward the RX data to the computing platform (e.g., via the PCIe link) based on a power schedule of the platform. For example, two receive buffer thresholds TR1 and TR2 may be used, at least in part, to control the flow of RX data from the RX buffer 510 to the computing platform. The first RX buffer threshold TR1 may represent a minimum data size for data bursts by the RX buffer 510 (e.g., threshold T1 of FIG. 1), and the second RX buffer threshold TR2 may represent a maximum allowable buffer fill level of the RX buffer 510 (e.g., threshold T2 of FIG. 1). Accordingly, the RX buffer 510 may selectively output RX data to the computing platform based on the two receive buffer thresholds TR1 and TR2, for example, as described above with reference to FIGS. 1 and 2.

The TX buffer 520 may fetch TX data from the computing platform (e.g., via the PCIe link) and output the TX data to an external device (e.g., via the Ethernet link). For example, two transmit buffer thresholds TT1 and TT2 may be used, at least in part, to control the fetching of TX data by the TX buffer 520 from the computing platform. The first TX buffer threshold TT1 may represent a buffer fill cut-off for the TX buffer 520 during an accumulation stage (e.g., threshold T1 of FIG. 3), and the second TX buffer threshold TT2 may represent a minimum fill level for the TX buffer 520 during a low-power stage (e.g., threshold T2 of FIG. 3). Accordingly, the TX buffer 520 may selectively retrieve TX data from the computing platform based on the two transmit buffer thresholds TT1 and TT2, for example, as described above with reference to FIGS. 3 and 4.

For some embodiments, the operations of the RX buffer 510 may be coordinated, at least in part, with the operations of the TX buffer 520, and vice-versa. For example, because the PCIe link may be shared between the RX buffer 510 and the TX buffer 520, the device 500 may awaken the computing platform from a low-power idle state less frequently by interleaving both RX and TX data communications to and/or from the computing platform whenever the platform is in an active state. Specifically, the RX buffer 510 may “borrow” an active window of the TX buffer 520 to forward RX data to the computing platform. Similarly, the TX buffer 520 may borrow an active window of the RX buffer 510 to retrieve TX data from the computing platform.

An “active window” is defined herein as the state where the computing platform is active and the PCIe link is “reserved” for communications by either the RX buffer 510 or the TX buffer 520. The active window may be requested (and/or triggered) when either the RX buffer 510 or the TX buffer 520 independently initiates a communication with the computing platform (e.g., thereby awakening the platform from a low-power idle state). For example, an active window of the TX buffer 520 may correspond with a duration wherein the computing platform is active and the PCIe link is reserved for the TX buffer 520 to retrieve TX data from the platform. An active window of the RX buffer 510 may correspond with a duration wherein the computing platform is active and the PCIe link is reserved for the RX buffer 510 to transmit RX data to the platform.

It should be noted that while the PCIe link may be reserved for a particular one of the data buffers (510 or 520), that data buffer may not be actively communicating with the computing platform throughout the entire duration of its active window. Accordingly, the present embodiments may enable the other data buffer (i.e., the one that did not request the active window) to communicate with the computing platform during “gaps” in communication between the platform and the data buffer for which the PCIe link is reserved. For example, when the RX buffer 510 requests an active window, the computing platform may first respond to the active window request with a message indicating that it has enough local buffer space available to store the incoming RX data. However, there is often a delay between the sending of an active window request and the receipt of a response message, depending on how quickly the computing platform is able to allocate enough space in its local buffer to store the RX data. Accordingly, the TX buffer 520 may take advantage of that (short) period of time wherein the computing platform is active, but the PCIe link is not yet being used, to fetch TX data from the computing platform. In another example, when the PCIe link is reserved for the TX buffer 520, there may be a delay between the time the TX buffer 520 sends a data fetch request to the computing platform and the time the TX buffer 520 actually begins receiving TX data from the platform. Thus, the RX buffer 510 may take advantage of that period of time wherein the computing platform is active, but the PCIe link is not in use, to forward RX data to the computing platform.

For some embodiments, the device 500 may be configured to output an LTR message indicating its latency requirements. As described above, the latency requirements may correspond with the buffer fill levels of the RX buffer 510 and/or the TX buffer 520. For some embodiments, the LTR message may be based on the data rates at which the device 500 receives RX data and/or forwards RX data to the computing platform. The LTR message may also be based on the data rates at which the device 500 retrieves TX data from the computing platform and/or outputs TX data to an external device. For some embodiments, the LTR message may be further based on the time it takes the computing platform to transition from a low-power idle state to an active state.

For some embodiments, the device 500 may receive a system idle signal indicating a current power state of the platform. As described above, the system idle signal may indicate an OBFF event (e.g., CPU Active, OBFF, or Idle). The device 500 may use the information from the system idle signal to determine whether the computing platform is in an active or idle state, and thus selectively enable and/or disable communications with the computing platform.

Coordinating TX data and RX data in the manner described above enables the PCIe link to be used more efficiently (e.g., sparingly). This, in turn, may allow the computing platform to remain in a low-power idle state for longer durations without being interrupted by the endpoint device 500. For some embodiments, the TX buffer 520 may be further configured to transmit TX data, via the Ethernet link, to an external device only when the RX buffer 510 receives RX data over the Ethernet link. By coordinating the transmission and reception of data over the Ethernet link, components that interface the device 500 with the Ethernet link (e.g., transmitters and/or receivers) may also enter a low power state when the Ethernet link is not actively in use.

For some embodiments, the endpoint device 500 may include multiple TX and/or RX buffers (e.g., which may enable the device 500 to simultaneously communicate with multiple external devices). Such a plurality of TX and/or RX buffers may also communicate with the computing platform in a coordinated manner (e.g., similar to what is described above) to further improve PCIe link efficiency. For other embodiments, only one of the RX buffer 510 or TX buffer 520 may be active at a time. Accordingly, the inactive data buffer should not affect the operations of the active data buffer. For example, if the RX buffer 510 is in an inactive state and the TX buffer 520 is active, the TX buffer 520 may operate as if the RX active window never occurs while following its own buffer usage model (e.g., data buffering operation 400 of FIG. 4).

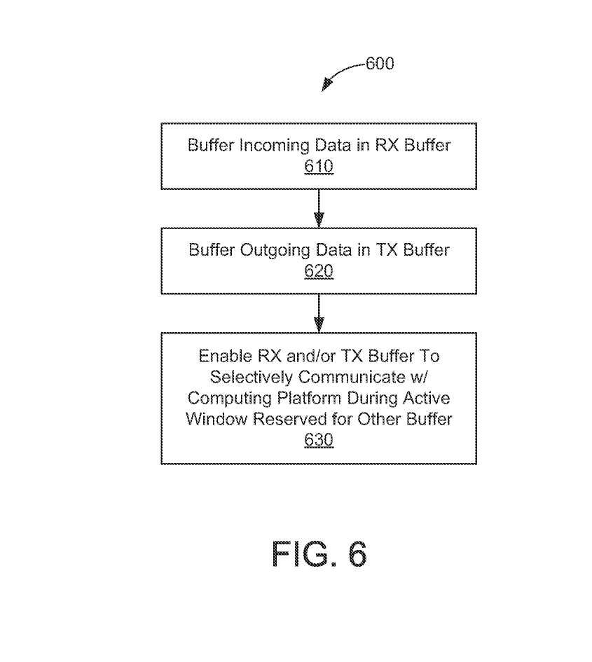

FIG. 6 is an illustrative flowchart depicting an exemplary operation 600 for buffering incoming and outgoing data in a coordinated fashion, in accordance with some embodiments. With reference, for example, to FIG. 5, the device 500 begins buffering incoming RX data in the RX buffer 510 (610). When independently buffering incoming data, the RX buffer 510 may follow, at least in part, the data buffering operation 200 described above with reference to FIG. 2.

The device 500 also begins fetching and buffering outgoing TX data in the TX buffer 520 (620). When independently buffering outgoing data, the TX buffer 520 may follow, at least in part, the data buffering operation 400 described above with reference to FIG. 4. For some embodiments, the RX buffer 510 may buffer the RX data at substantially the same time that the TX buffer 520 is buffering TX data.

The device 500 may then enable the RX buffer 510 and/or TX buffer 520 to selectively communicate with the computing platform during an active window reserved for the other data buffer (630). For example, when the TX buffer 520 requests an active window to retrieve TX data from the computing platform (e.g., based on the data buffering operation 400 of FIG. 4), the device 500 may monitor the activity on the shared PCIe link to detect one or more gaps in communication between the TX buffer 520 and the platform. The device 500 may then enable the RX buffer 510 to forward RX data to the computing platform, via the PCIe link, during such gaps in communication between the TX buffer 520 and the platform.

Similarly, when the RX buffer 510 requests an active window to forward RX data to the computing platform (e.g., based on the data buffering operation 200 of FIG. 2), the device 500 may monitor the activity on the shared PCIe link to detect one or more gaps in communication between the RX buffer 510 and the platform. The device 500 may then enable the TX buffer 520 to retrieve TX data from the computing platform, via the PCIe link, during such gaps in communication between the RX buffer 510 and the platform.

For some embodiments, the data buffering operation 600 allows the RX buffer 510 and TX buffer 520 to independently follow their own buffer usage models (e.g., data buffering operations 200 and 400, respectively), until an active window is requested or initiated by one of the data buffers 510 or 520. Thereafter, the operation 600 allows one of the data buffers 510 or 520 to borrow or share the active window of the other data buffer to communicate with the computing platform when the shared PCIe link is not in use by the other data buffer.

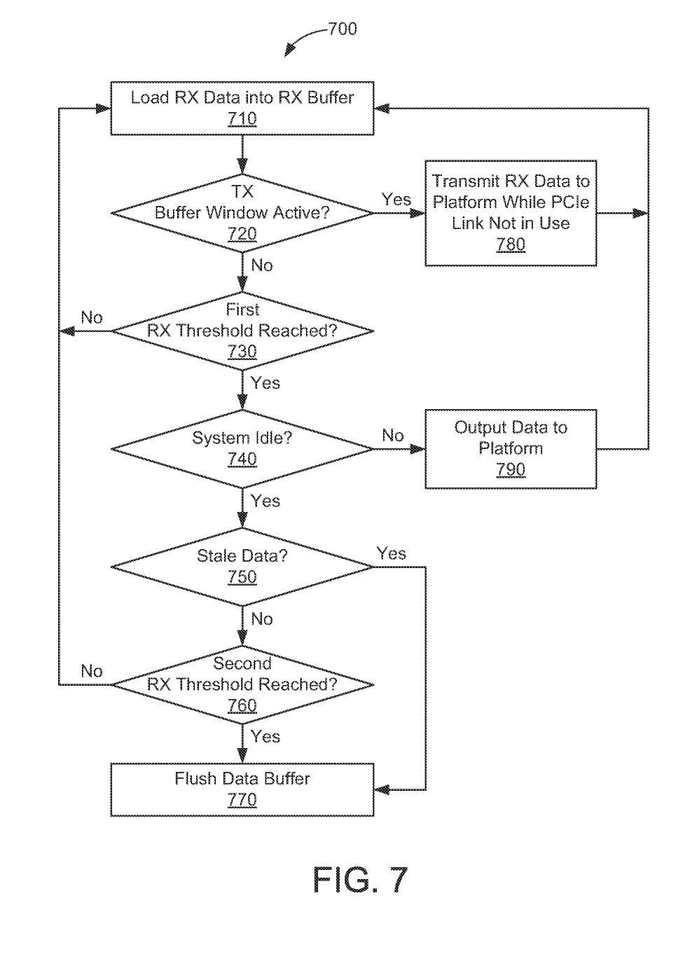

FIG. 7 is an illustrative flowchart depicting an exemplary operation 700 for buffering incoming data in coordination with outgoing data, in accordance with some embodiments. With reference, for example, to FIG. 5, the device 500 receives an RX data signal and loads the received RX data into the RX buffer 510 (710). The device 500 then determines whether an active window has been requested and/or reserved by the TX buffer 520 (720). If no active window is detected (720), the device 500 may subsequently determine whether the first RX buffer threshold TR1 has been reached (730). As long as the first RX buffer threshold TR1 has not been reached (730), and no active window is detected (720), the device 500 may continue to load RX data into the RX buffer 510 (710).

However, if at any time the device 500 detects an open active window for the TX buffer 520 (720), the device 500 may enable the RX buffer 510 to output RX data to the computing platform during one or more periods wherein the shared PCIe link is not being used by the TX buffer 520 (780) while continuing to load RX data into the RX buffer 510 (710).As described above, the first RX buffer threshold TR1 may correspond to a minimum data size for RX data bursts to the computing platform for purposes of reducing the frequency of waking up the platform from a low-power idle state. However, since the computing platform is already in an active state when an active window is reserved for the TX buffer 520, the RX buffer 510 may transmit RX data to the computing platform during the active window, regardless of whether the first RX buffer threshold has been reached.

If the device 500 does not detect an open active window for the TX buffer 520 (720), and the buffer fill level of the RX buffer 510 is at or above the first RX buffer threshold TR1 (730), the device 500 may then determine whether the platform is currently in a low-power idle state (740). As described above, the device 500 may perform this determination based on the OBFF event (e.g., CPU Active, Idle, or OBFF) indicated by the system idle signal. If the device 500 determines that the platform is not in a low-power idle state (740), it may output RX data from the RX buffer 510 to the computing platform (790) while continuing to load RX data into the RX buffer 510 (710).

If the device 500 determines that the computing platform is in a low-power idle state (740), it may then determine whether the RX buffer 510 contains any stale data (750). If the device 500 detects stale data in the RX buffer 510 (750), it may initiate a data flush operation (770) by outputting all or most of the data stored in the RX buffer 510 to the computing platform. In order to ensure that RX data is delivered to the computing platform in a timely manner, the device 500 may be configured to flush stale data from the RX buffer 510 regardless of whether the platform is in a low-power idle state.

If the RX buffer 510 does not contain any stale data (750), the device 500 may then determine whether the second RX buffer threshold TR2 has been reached (760). As long as the second threshold TR2 has not been reached (760), the device 500 may continue to store RX data in the RX buffer 510 (710) without forwarding such data to the computing platform. This is to prevent the device 500 from unnecessarily interrupting the low-power idle state of the computing platform.

However, if the buffer fill level reaches the second RX threshold TR2 (760), the device 500 may flush the data stored in the RX buffer 510 (770). As described above, the second RX buffer threshold TR2 may ensure that the device 500 is able to flush the data from the RX buffer 510 while there is still enough excess buffer capacity to store any subsequent RX data that may arrive during the buffer-flush latency period. Accordingly, the device 500 may be configured to flush the data stored in the RX buffer 510 as soon as the second RX buffer threshold TR2 is reached, regardless of whether the computing platform is in a low-power idle state.

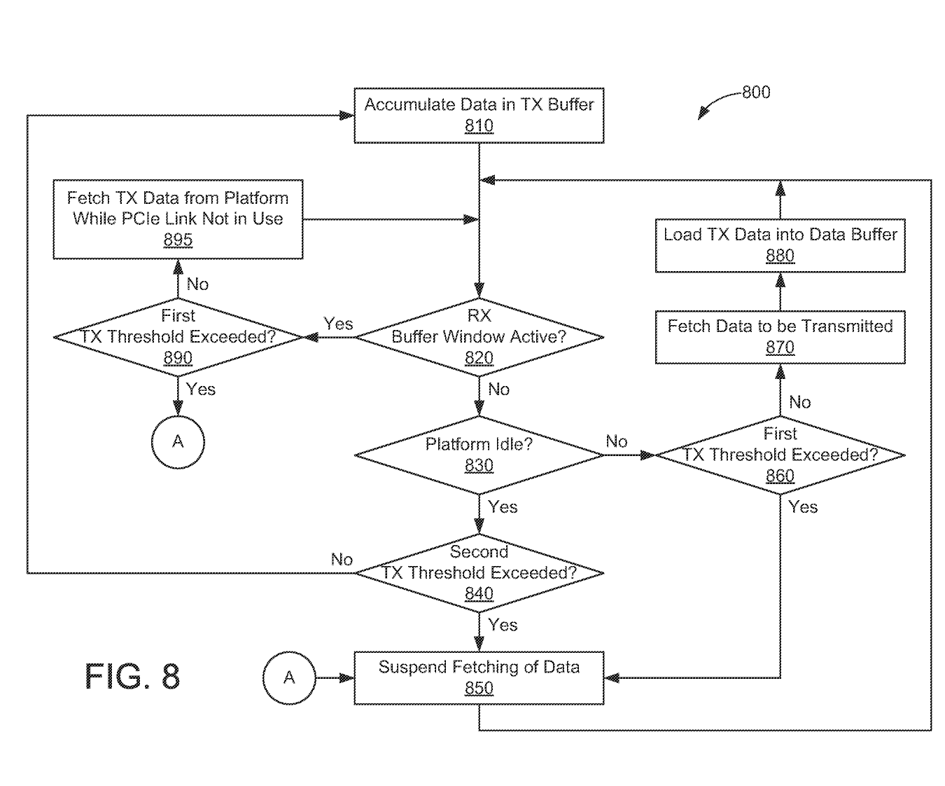

FIG. 8 is an illustrative flowchart depicting an exemplary operation 800 for buffering outgoing data in coordination with incoming data, in accordance with some embodiments. With reference, for example, to FIG. 5, the device 500 begins by accumulating TX data in the TX buffer 520 (810). The device 500 may accumulate data by continuously fetching TX data from the computing platform until the buffer fill level of the TX buffer 520 reaches the first TX buffer threshold TT1 (e.g., as described above with respect to the accumulation stage 410 of FIG. 4).

The device 500 then determines whether an active window has been requested and/or reserved by the RX buffer 510 (820). If no active window is detected (820), the device 500 may subsequently determine whether the computing platform is currently in a low-power idle state (830). As described above, the device 500 may perform this determination based on the OBFF event indicated by the system idle signal. If the device 500 determines that the platform is not in a low-power idle state (830), it may then determine whether the buffer fill level of the TX buffer 520 currently exceeds the first TX buffer threshold TT1 (860). As long as the buffer fill level is at or above the first TX buffer threshold TT1 (860), the device 500 may temporarily suspend fetching of additional TX data (850) while continuing to monitor whether an active window has been allocated for the RX buffer 510 (820) as well as the idle state of the computing platform (830).

If the computing platform is not in a low-power idle state (830) and the buffer fill of the TX buffer 520 is below the first TX buffer threshold TT1 (860), the device 500 may proceed to fetch additional TX data from the computing platform (870) and load the data in the TX buffer 520 (880). However, if at any time the device 500 determines that the computing platform is in a low-power idle state (830), the device 500 may subsequently determine whether the buffer fill level of the TX buffer 520 currently exceeds the second TX buffer threshold TT2 (840). If the amount of data stored in the TX buffer 520 remains at or above the second TX buffer threshold TT2 (840), the device 500 may temporarily suspend requests to fetch additional TX data (850) while continuing to monitor whether an active window has been allocated for the RX buffer 510 (820) as well as the idle state of the computing platform (830). If the computing platform is in a low-power idle state (830) and the buffer fill level of the TX buffer 520 falls below the second TX buffer threshold TT2 (840), the device 500 may reenter the accumulation stage (810).

If, at any time, the device 500 detects an open active window for the RX buffer 510 (820), the device 500 may enable the TX buffer 520 to fetch TX data from the computing platform during one or more periods wherein the shared PCIe link is not actively being used by the RX buffer 510 (895), as long as the buffer fill level of the TX buffer 520 is below the first TX buffer threshold TT1 (890). As described above, the first TX buffer threshold TT1 may correspond with a maximum fill level of the TX buffer 520. Thus, if the amount of data stored in the TX buffer 520 is at or above the first TX buffer threshold TT1, the device 500 may not fetch additional TX data regardless of whether an active window has been allocated for the RX buffer 510 or the computing platform is in an active state. For some embodiments, the device 500 may continue to fetch TX data from the computing platform (895) until the amount of data stored in the TX buffer 520 has exceeded the first TX threshold (890) and/or the RX buffer active window has expired (820).

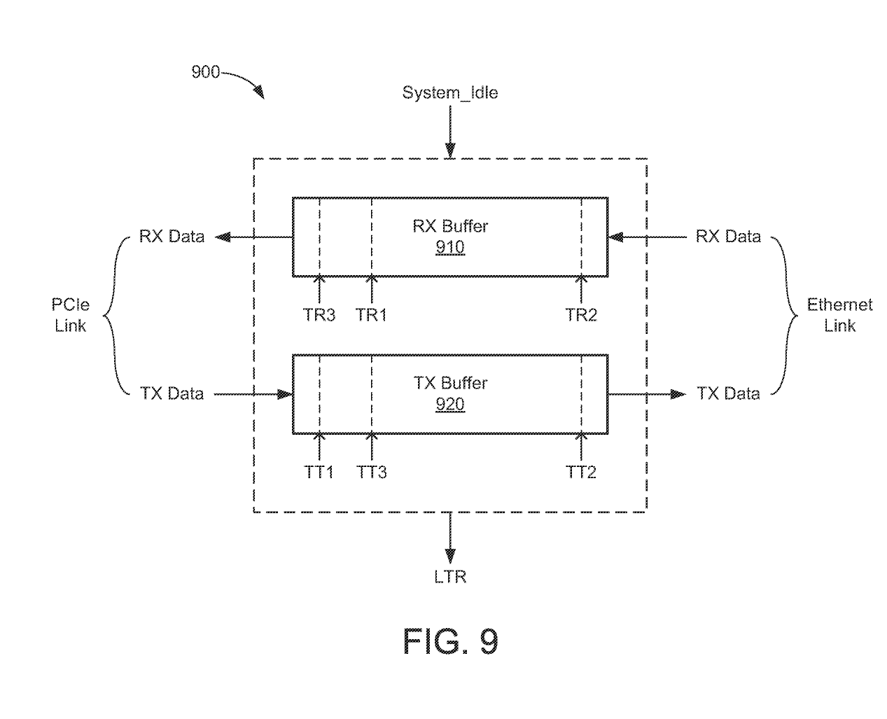

FIG. 9 shows another embodiment of an endpoint device 900 for transferring incoming and outgoing data over a shared communications medium between an external device and a computing platform. The device 900 includes an RX buffer 910 and a TX buffer 920. The endpoint device 900 may communicate with an external device via a network channel, while communicating with the computing platform via a shared communications medium (e.g., a PCIe link).

For some embodiments, data buffer 910 and data buffer 920 perform a similar function as data buffer 510 and data buffer 520, respectively, as described above with reference to FIG. 5. That is, the RX buffer 910 may temporarily store RX data received from an external device (e.g., via the Ethernet link) and forward the RX data to the computing platform (e.g., via the PCIe link) based on a power schedule of the platform. The TX buffer 920 may fetch TX data from the computing platform (e.g., via the PCIe link) and output the TX data to an external device (e.g., via the Ethernet link). Furthermore, the RX buffer 910 may borrow an active window of the TX buffer 920 to communicate with the computing platform, and vice-versa (e.g., as described above with respect to FIGS. 5 and 6).

For some embodiments, three receive buffer thresholds TR1-TR3 are used to control the flow of RX data from the RX buffer 910 to the computing platform. The first RX buffer threshold TR1 may represent a minimum data size for data bursts (e.g., similar to the buffer threshold T1 of FIG. 1). The second RX buffer threshold TR2 may represent a maximum buffer fill level for the RX buffer 910 (e.g., similar to the buffer threshold T2 of FIG. 1). However, the third RX buffer threshold TR3 may represent a buffer “flush” level. That is, when a data flush operation is executed for the RX buffer 910, the device 900 may continuously output RX data from the RX buffer 910 until the amount of data stored therein falls below at least the third RX buffer threshold TR3. For some embodiments, the third RX buffer threshold TR3 is lower than the first and second RX buffer threshold TR1 and TR2.

For some embodiments, the three buffer thresholds TT1-TT3 are also used to control the fetching of TX data by the TX buffer 920 from the computing platform. The first TX buffer threshold TT1 may represent a buffer fill cut-off for the TX buffer 920 (e.g., similar to the buffer threshold T1 of FIG. 3). The second TX buffer threshold TT2 may represent a minimum buffer fill level for the TX buffer 920 (e.g., similar to the buffer threshold T2 of FIG. 3). However, the third TX buffer threshold TT3 may represent a “desired” buffer fill level. That is, the device 900 may selectively fetch TX data from the computing platform based on the system idle signal when the amount of data stored in the TX buffer 920 falls between the third TX buffer threshold TT3 and the second TX buffer threshold TT2.For some embodiments, the third TX buffer threshold TT3 is lower than the first TX buffer threshold TT1 and greater than the second TX buffer threshold TT2.

For some embodiments, the device 900 may be configured to output an LTR message indicating its latency requirements. As described above, the latency requirements may correspond with the buffer fill levels of the RX buffer 910 and/or the TX buffer 920. For some embodiments, the LTR message may be based on the data rates at which the device 900 receives RX data and/or forwards RX data to the computing platform. The LTR message may also be based on the data rates at which the device 900 retrieves TX data from the computing platform and/or transmits TX data to an external device. For some embodiments, the LTR message may be further based on the time it takes the computing platform to transition from a low-power idle state to an active state.

For some embodiments, the device 900 may receive a system idle signal indicating a current power state of the platform. As described above, the system idle signal may indicate an OBFF event (e.g., CPU Active, OBFF, or Idle). The device 900 may use the information from the system idle signal to determine whether the computing platform is in an active or idle state, and thus selectively enable and/or disable communications with the computing platform.

For some embodiments, the endpoint device 900 may include multiple TX and/or RX buffers. Such a plurality of TX and/or RX buffers may also communicate with the computing platform in a coordinated manner to further improve PCIe link efficiency. For other embodiments, only one of the RX buffer 910 or TX buffer 920 may be active at a time. Accordingly, the inactive data buffer should not affect the operations of the active data buffer.

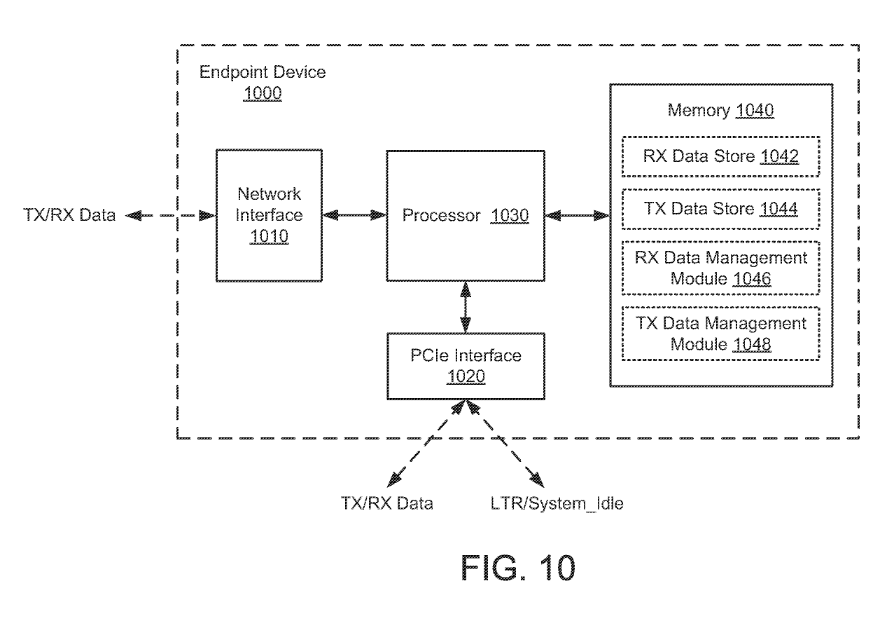

FIG. 10 shows yet another embodiment of an endpoint device 1000 for transferring incoming and outgoing data over a shared communications medium between an external device and a computing platform. The device 1000 includes a network interface 1010, a PCIe interface 1020, a local processor 1030, and a memory 1040. The network interface 1010 is coupled to the processor 1030 and may receive RX data, as well as output TX data, via a network channel. The PCIe interface 1020 is also coupled to the processor 1030 and may receive TX data, as well as output RX data, via a PCIe link. For some embodiments, the PCIe interface 1020 may also receive a system idle signal and/or output a LTR messages via the PCIe link.

Memory 1040 may include an RX data store 1042 and a TX data store 1044. The RX data store 1042 may be used to temporarily store received RX data, and the TX data store 1044 may be used to temporarily store outgoing TX data. Furthermore, memory 1040 may also include a non-transitory computer-readable storage medium (e.g., one or more nonvolatile memory elements, such as EPROM, EEPROM, Flash memory, a hard drive, etc.) that can store the following modules:
an incoming (RX) data management module 1046 to control a forwarding of RX data to the computing platform based, at least in part, on an idle state of the platform; and
an outgoing (TX) data management module 1048 to control a fetching of TX data form the computing platform based, at least in part, on the idle state of the platform.
   Each module may include instructions (e.g., software) that, when executed by the local processor 1030, may cause the device 1000 to perform the corresponding function. Thus, the non-transitory computer-readable storage medium of memory 1040 may include instructions for performing all or a portion of the operations described with respect to FIGS. 2, 4, and 6-8. For other embodiments, one or more of the modules 1046 and/or 1048 may be implemented in firmware, circuitry, or any other form of hardware capable of performing the operations described above.

The local processor 1030, which is coupled to the memory 1040, may be any suitable processor capable of executing scripts of instructions of one or more software programs stored in the device 1000 (e.g., within memory 1040). For example, the processor 1030 can execute the RX data management module 1046 and/or the TX data management module 1048.

The RX data management module 1046 may be executed by the local processor 1030 to selectively output RX data from the RX data store 1042 to the computing platform based, at least in part, on an idle state of the platform. For example, the RX data management module 1046, as executed by the local processor 1030, may monitor the amount of data stored in the RX data store 1042 and selectively output the RX data to the computing platform based on two or more RX buffer thresholds (e.g., as described above with respect to FIGS. 1, 3, 5 and 9) and whether or not the computing platform is in a low-power idle state (e.g., as described above with respect to FIGS. 2 and 7). For some embodiments, the processor 1030, in executing the RX data management module 1046, may further detect whether an active window has been allocated by the computing platform for the retrieval of TX data. Upon detecting such an active window, the processor 1030, in executing the RX data management module 1046, may forward RX data from the RX data store 1042 to the computing platform during one or more periods wherein the PCIe link is not being used (e.g., as described above with respect to FIGS. 6 and 7).

The TX data management module 1048 may be executed by the local processor 1030 to selectively fetch TX data from the computing platform based, at least in part, on the idle state of the platform. For example, the TX data management module 1048, as executed by the local processor 1030, may monitor the amount of data stored in the TX data store 1044 and selectively retrieve additional TX data from the computing platform based on two or more TX buffer thresholds (e.g., as described above with respect to FIGS. 1, 3, 5 and 9) and whether or not the computing platform is in a low-power idle state (e.g., as described above with respect to FIGS. 4 and 8). For some embodiments, the processor 1030, in executing the TX data management module 1048, may further detect whether an active window has been allocated by the computing platform for the forwarding of RX data. Upon detecting such an active window, the processor 1030, in executing the TX data management module 1048, may retrieve TX data from the computing platform during one or more periods wherein the PCIe link is not being used, as long as the amount of data in the TX data store 1044 has not yet reached a maximum fill level (e.g., as described above with respect to FIGS. 6 and 8).

By buffering incoming and outgoing data, and selectively communicating such data to and from the computing platform based on an “idle” (or “active”) state of the platform, the present embodiments may enable the computing platform to enter a low-power idle state more frequently and/or remain in the low-power idle state for longer durations. Furthermore, enabling one data buffer to “borrow” the active window of another data buffer allows the shared communications medium (e.g., PCIe link) to be used more efficiently (and sparingly). This in turn, may further enable the computing platform to remain in the idle state for even longer durations.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense. For example, the method steps depicted in the flow charts of FIGS. 2, 4, and 6-8 may be performed in other suitable orders, multiple steps may be combined into a single step, and/or some steps may be omitted.

What is claimed is:

1. A method of operating an endpoint device coupled to a computing platform, the method comprising:
buffering outgoing data in a first data buffer, wherein the outgoing data is to be transmitted to an external device via a first communications medium;
buffering incoming data in a second data buffer, wherein the incoming data is received from the external device via the first communications medium; and
enabling at least one of the first or second data buffers to selectively communicate with the computing platform, via a second communications medium, during an active window of the other data buffer.

2. The method of claim 1, wherein enabling one of the first or second data buffer comprises at least one member of the group including:
enabling the first data buffer to retrieve data from the computing platform, via the second communications medium, during an active window of the second buffer in which the second communications medium is reserved for the second data buffer to transmit data to the computing platform; and
enabling the second data buffer to transmit data to the computing platform, via the second communications medium, during an active window of the first buffer in which the second communications medium is reserved for the first data buffer to retrieve data from the computing platform.

3. The method of claim 2, wherein the first data buffer retrieve the data during one or more gaps in communications between the computing platform and the second data buffer, and the first data buffer transmits the data during one or more gaps in communications between the computing platform and the first data buffer.

4-5. (canceled)

6. The method of claim 1, further comprising:
selectively allocating the active window for at least one of the first or second data buffers based, at least in part, on a system idle signal.

7. The method of claim 6, wherein selectively allocating the active window for the first data buffer comprises:
allocating a first active window for the first data buffer;
enabling the first data buffer to retrieve data from the computing platform, during the first active window, until an amount of data in the first data buffer is at or above a first transmit threshold;
allocating a second active window for the first data buffer if the amount of data in the first data buffer is below a second transmit threshold, wherein the second transmit threshold is less than the first transmit threshold;
enabling the first data buffer to retrieve data from the computing platform, during the second active window, until the amount of data in the first data buffer is at or above the first transmit threshold; and
terminating the first active window of the first data buffer once the amount of data in the first data buffer is at or above the first transmit threshold.

8. (canceled)

9. The method of claim 4, wherein selectively allocating the active window for the first data buffer further comprises at least one member of the group including:
allocating a third active window for the first data buffer if the amount of data in the first data buffer is below at least the first transmit threshold and the system idle signal indicates that the computing platform is in an active state; and
preventing allocation of the third active window if the system idle signal indicates that the computing platform is in a low-power idle state or the amount of data in the first data buffer is at or above the first transmit threshold.

10. The method of claim 9, wherein allocating the third active window for the first data buffer comprises:
allocating the third active window if the amount of data in the first data buffer is below a third transmit threshold and the system idle signal indicates that the computing platform is in an active state; and
enabling the first data buffer to retrieve data from the computing platform, during the third active window, as long as the amount of data in the first data buffer is at or below the first transmit threshold;
wherein the third transmit threshold is less than the first transmit threshold and greater than the second transmit threshold, and wherein at least one of the first, second, or third transmit thresholds is determined based on a latency requirement of the first data buffer.

11-12. (canceled)

13. The method of claim 1, further comprising:
enabling the first data buffer to output a latency tolerance requirement (LTR) message to the computing platform indicating the latency requirement of the first data buffer.

14. The method of claim 6, wherein selectively allocating the active window for the second data buffer comprises:
allocating a first active window for the second data buffer if an amount of data in the second data buffer is at or above a first receive threshold and the system idle signal indicates that the computing platform is in an active state;
enabling the second data buffer to transmit data to the computing platform during the first active window; and
preventing allocation of the first active window if the system idle signal indicates that the computing platform is in a low-power idle state or the amount of data in the second data buffer is below the first receive threshold.

15. (canceled)

16. The method of claim 9, wherein selectively allocating the active window for the second data buffer further comprises:
allocating a second active window for the second data buffer if the amount of data in the second data buffer is at or above a second receive threshold, wherein the second receive threshold is greater than the first receive threshold;
enabling the second data buffer to transmit data to the computing platform during the second active window until the amount of data in the second data buffer is below at least the first receive threshold; and
terminating the second active window of the second data buffer once the amount of data in the second data buffer is below at least the first receive threshold.

17. (canceled)

18. The method of claim 16, wherein selectively allocating the active window for the second data buffer further comprises:
allocating a third active window for the second data buffer if any of the data in the second data buffer has been stored for longer than a duration; and
enabling the second data buffer to transmit data to the computing platform during the third active window until the amount of data in the second data buffer is at or below the third receive threshold.

19-20. (canceled)

21. The method of claim 1, wherein the first communications medium is an Ethernet link, and wherein the second communications medium is a Peripheral Component Interconnect Express (PCIe) link.

22. The method of claim 6, wherein the system idle signal is an Optimized Buffer Flush/Fill (OBFF) indicator signal.

23. A non-transitory computer-readable storage medium containing program instructions that, when executed by a processor of a communications device, causes the device to:
buffer outgoing data in a first data buffer, wherein the outgoing data is to be transmitted to an external device via a first communications medium;
buffer incoming data in a second data buffer, wherein the incoming data is received from the external device via the first communications medium; and
enable one of the first or second data buffers to selectively communicate with a computing platform, via a second communications medium, during an active window of the other data buffer.

24. The non-transitory computer-readable storage medium of claim 23, wherein execution of the program instructions to enable one of the first or second data buffers causes the device to perform at least one member of the group of operations including:
enabling the first data buffer to retrieve data from the computing platform, via the second communications medium, during an active window of the second buffer in which the second communications medium is reserved for the second data buffer to transmit data to the computing platform; and
enabling the second data buffer to transmit data to the computing platform, via the second communications medium, during an active window of the first buffer in which the second communications medium is reserved for the first data buffer to retrieve data from the computing platform.

25. The non-transitory computer-readable storage medium of claim 24, wherein the first data buffer is to retrieve the data during one or more gaps in communications between the computing platform and the second data buffer, and the second data buffer is to transmit the data during one or more gaps in communications between the computing platform and the first data buffer.

26-27. (canceled)

28. The non-transitory computer-readable storage medium of claim 23, wherein execution of the program instructions causes the device to further:
selectively allocate an active window for at least one of the first or second data buffers based, at least in part, on a system idle signal.

29. The non-transitory computer-readable storage medium of claim 28, wherein execution of the program instructions to selectively allocate an active window for the first data buffer causes the device to:
allocate a first active window for the first data buffer;
enable the first data buffer to retrieve data from the computing platform, during the first active window, until an amount of data in the first data buffer is at or above a first transmit threshold;
allocate a second active window for the first data buffer if the amount of data in the first data buffer is below a second transmit threshold, wherein the second transmit threshold is less than the first transmit threshold;
enable the first data buffer to retrieve data from the computing platform, during the second active window, until the amount of data in the first data buffer is at or above the first transmit threshold; and
terminate the first active window of the first data buffer once the amount of data in the first data buffer is at or above the first transmit threshold.

30. The non-transitory computer-readable storage medium of claim 29, wherein execution of the program instructions to selectively allocate an active window for the first data buffer causes the device to perform at least one member of the group of operations including:
allocating a third active window for the first data buffer if the amount of data in the first data buffer is below at least the first transmit threshold and the system idle signal indicates that the computing platform is in an active state; and
preventing allocation of the third active window if the system idle signal indicates that the computing platform is in a low-power idle state or the amount of data in the first data buffer is at or above the first transmit threshold.

31. The non-transitory computer-readable storage medium of claim 30, wherein execution of the program instructions for allocating the third active window for the first data buffer causes the device to:
allocate the third active window if the amount of data in the first data buffer is below a third transmit threshold and the system idle signal indicates that the computing platform is in an active state; and
enable the first data buffer to retrieve data from the computing platform, during the third active window, as long as the amount of data in the first data buffer is at or below the first transmit threshold;
wherein the third transmit threshold is less than the first transmit threshold and greater than the second transmit threshold, and wherein at least one of the first, second, or third transmit thresholds is determined based on a latency requirement of the first data buffer.

32. (canceled)

33. The non-transitory computer-readable storage medium of claim 23, wherein execution of the program instructions causes the device to further:
enable the first data buffer to output a latency tolerance requirement (LTR) message to the computing platform indicating a latency requirement of the first data buffer.

34-35. (canceled)

36. The non-transitory computer-readable storage medium of claim 28, wherein execution of the program instructions to selectively allocate the active window for the second data buffer cause the device to:
allocate a first active window for the second data buffer if an amount of data in the second data buffer is at or above a first receive threshold and the system idle signal indicates that the computing platform is in an active state;
enable the second data buffer to transmit data to the computing platform during the first active window; and
prevent allocation of the first active window if the system idle signal indicates that the computing platform is in a low-power idle state or the amount of data in the second data buffer is below the first receive threshold.

37. (canceled)

38. The non-transitory computer-readable storage medium of claim 36, wherein execution of the program instructions to selectively allocate the active window for the second data buffer further causes the device to further:
allocate a second active window for the second data buffer if the amount of data in the second data buffer is at or above a second receive threshold, wherein the second receive threshold is greater than the first receive threshold;
enable the second data buffer to transmit data to the computing platform during the second active window until the amount of data in the second data buffer is below at least the first receive threshold; and
terminate the second active window of the second data buffer once the amount of data in the second data buffer is below at least the first receive threshold.

39. The non-transitory computer-readable storage medium of claim 38, wherein execution of the program instructions to selectively allocate the active window for the second data buffer causes the device to further:
allocate a third active window for the second data buffer if any of the data in the second data buffer has been stored for longer than a duration; and
enable the second data buffer to transmit data to the computing platform during the third active window until the amount of data in the second data buffer is at or below the third receive threshold.

40-42. (canceled)

43. The non-transitory computer-readable storage medium of claim 23, wherein the first communications medium is an Ethernet link, and wherein the second communications medium is a Peripheral Component Interconnect Express (PCIe) link.

44. The non-transitory computer-readable storage medium of claim 28, wherein the system idle signal is an Optimized Buffer Flush/Fill (OBFF) indicator signal.

45. An endpoint device, comprising:
a first data buffer to buffer outgoing data to be transmitted to an external device via a first communications medium; and
a second data buffer to buffer incoming data received from the external device via the first communications medium;
wherein at least one of the first or second data buffers is to selectively communicate with a computing platform, via a second communications medium, during an active window of the other data buffer.

46. The endpoint device of claim 45, wherein:
the first data buffer is to retrieve data from the computing platform, via the second communications medium, during an active window in which the second communications medium is reserved for the second data buffer to transmit data to the computing platform; and
the second data buffer is to transmit data to the computing platform, via the second communications medium, during an active window in which the second communications medium is reserved for the first data buffer to retrieve data from the computing platform.

47-48. (canceled)

49. The endpoint device of claim 46, wherein:
the first data buffer is to retrieve the data from the computing platform during one or more gaps in communications between the computing platform and the second data buffer; and
the second data buffer is to transmit the data to the computing platform during one or more gaps in communications between the computing platform and the first data buffer.

50. The endpoint device of claim 45, wherein at least one of the first or second data buffers is to selectively request an active window based, at least in part, on a system idle signal.

51. The endpoint device of claim 50, wherein the first data buffer is to further:
request a first active window;
retrieve data from the computing platform, during the first active window, until an amount of data in the first data buffer is at or above a first transmit threshold;
request a second active window if the amount of data in the first data buffer is below a second transmit threshold, wherein the second transmit threshold is less than the first transmit threshold;
retrieve data from the computing platform, during the second active window, until the amount of data in the first data buffer is at or above the first transmit threshold; and
terminate the first active window once the amount of data in the first data buffer is at or above the first transmit threshold.

52. (canceled)

53. The endpoint device of claim 51, wherein the first data buffer is to further:
request a third active window if the amount of data in the first data buffer is below at least the first transmit threshold and the system idle signal indicates that the computing platform is in an active state; and
not request the third active window if the system idle signal indicates that the computing platform is in a low-power idle state or the amount of data in the first data buffer is at or above the first transmit threshold.

54. The endpoint device of claim 53, wherein the first data buffer is to further:
request the third active window if the amount of data in the first data buffer is below a third transmit threshold and the system idle signal indicates that the computing platform is in an active state; and
retrieve data from the computing platform, during the third active window, as long as the amount of data in the first data buffer is at or below the first transmit threshold;
wherein the third transmit threshold is less than the first transmit threshold and greater than the second transmit threshold, and wherein at least one of the first, second, or third transmit thresholds is determined based on a latency requirement of the first data buffer.

55-56. (canceled)

57. The endpoint device of claim 45, wherein the first data buffer is to output an LTR message to the computing platform indicating at latency requirement of the first data buffer.

58. The endpoint device of claim 50, wherein the second data buffer is to further:
request a first active window if an amount of data in the second data buffer is at or above a first receive threshold and the system idle signal indicates that the computing platform is in an active state;
transmit data to the computing platform during the first active window; and
not request the first active window if the system idle signal indicates that the computing platform is in a low-power idle state or the amount of data in the second data buffer is below the first receive threshold.

59. (canceled)

60. The endpoint device of claim 58, wherein the second data buffer is to further:
request a second active window if the amount of data in the second data buffer is at or above a second receive threshold-, wherein the second receive threshold is greater than the first receive threshold;
transmit data to the computing platform during the second active window until the amount of data in the second data buffer is below at least the first receive threshold; and
terminate the second active window of the second data buffer once the amount of data in the second data buffer is below at least the first receive threshold.

61. (canceled)

62. The endpoint device of claim 60, wherein the second data buffer is to further:
request a third active window if any of the data in the second data buffer has been stored for longer than a threshold duration; and
transmit data to the computing platform during the third active window until the amount of data in the second data buffer is at or below the third receive threshold.

63-64. (canceled)

65. The endpoint device of claim 45, wherein the first communications medium is an Ethernet link, and wherein the second communications medium is a Peripheral Component Interconnect Express (PCIe) link.

66. The endpoint device of claim 50, wherein the system idle signal is an Optimized Buffer Flush/Fill (OBFF) indicator signal.

67. (canceled)
